(19) United States
(12) Patent Application Publication
(10) Pub. No.: US 2026/0307941 A1
(43) Pub. Date: Oct. 8, 2026

(54) GUIDE RAIL SEGMENT AND GUIDE RAIL ARRANGEMENT FOR AN ELEVATOR SYSTEM, AND CORRESPONDING PRODUCTION METHOD

(71) Applicant: INVENTIO AG, Hergiswil (CH)

(72) Inventors: Philipp Zimmerli, Härkingen (CH); Christian Studer, Kriens (CH)

(21) Appl. No.: 19/479,543

(22) PCT Filed: May 14, 2024
(86) PCT No.: PCT/EP2024/063174

§ 371 Date: Oct. 28, 2025

(30) Foreign Application Priority Data
May 15, 2023 (EP) 23173349.4

(51) Int. Cl. B66B 7/02

(52) U.S. Cl. CPC B66B 7/022

(57) ABSTRACT

A guide rail segment of a guide rail arrangement for an elevator system has an elongated hollow profile made of bent sheet metal and filler material. The hollow profile comprises an undercut groove extending in a longitudinal direction; first and second compartments projecting in opposite lateral directions next to the groove, and each forming support surfaces for the guide rail segment relative to a shaft wall of the elevator system; and a third compartment projecting from the groove in a height direction transverse to the lateral directions. The third compartment is delimited by partial regions of the bent sheet metal and, with opposite lateral surfaces, forms a guide surface for an elevator component displaced along the guide rail arrangement. The filler material is received in the third compartment so that it rests against the partial regions of the bent sheet metal delimiting the third compartment on the respective side.

### TECHNICAL FIELD

The present invention relates to a guide rail segment of a guide rail arrangement for an elevator system as well as to a corresponding guide rail arrangement and a corresponding elevator system. The invention further relates to a method for producing a guide rail segment.

### BACKGROUND

In an elevator system, a car is used to transport persons or objects between different floors. The car is guided along one or more guide rail arrangements during a displacement movement along an elevator shaft. For example, a guide shoe can be attached to the car and, when the car is moved, can be supported on a guide surface formed by the guide rail arrangement. In addition, the guide surface can be used as a braking surface, for example to slow down the car using a safety brake (also known as “safety gear”).

Conventionally, the guide rail arrangement is formed by a plurality of elongated guide rails, which are arranged one after the other in the longitudinal direction and abutting one another vertically along the elevator shaft, thus forming the continuous guide surface. Conventional guide rails are usually used as solid components in the form of steel profiles.

Such guide rails are generally manufactured using a hot rolling method and then cut to the desired lengths and post-processed. The production and post-processing can be relatively complex and may include, for example, the creation of holes for attaching rail connectors (also known as “fishplates”), the introduction of millings for the rail connectors, the creation of a tongue-and-groove connection by milling the corresponding tongue and groove, the generation of corrosion protection and/or the suitable creation of the guide surfaces by cold-drawing them. In addition, the guide rails, which are usually several meters long, are very heavy. For example, a guide rail with a typical length of 5 m can weigh well over 100 kg. This can involve a great deal of effort during transport or when mounting in the elevator shaft. In addition, a large amount of steel is required to produce conventional guide rails, which significantly increases production costs. In addition, when storing heavy rails, it may be necessary to ensure that they do not deform due to their own weight.

CN 215755826 U describes a guide rail element which is constructed in two parts, with a solid guide part being fastened to a base part in the form of a rolled sheet metal profile which is formed from sheet metal bent into a hollow profile.

### SUMMARY

There may be a need for an alternative guide rail segment which, among other things, at least partially avoids the above-mentioned problems of conventional guide rails. In particular, there may be a need for a guide rail segment which can be manufactured easily and/or with few post-processing steps, which has low weight or requires a small amount of material used to manufacture it, such as in particular high-quality steel, which is easy to store and/or transport, which enables improved installation accuracy and/or which can be manufactured and/or mounted overall with less effort and/or lower costs than conventional guide rails. Furthermore, there may be a need for a guide rail segment in which forces, such as those generated when guiding an elevator car, can be efficiently transferred to a supporting structure on which the guide rail segment is supported within the elevator shaft. In addition, there may be a need for a corresponding guide rail arrangement as well as a corresponding elevator system. Furthermore, there may be a need for a method for producing a corresponding guide rail segment.

Such a need can be met by the subject-matter according to the independent claims. Advantageous embodiments are defined in the dependent claims and in the following description or are illustrated in the accompanying figures.

According to a first aspect of the invention, a guide rail segment of a guide rail arrangement for an elevator system is described. The guide rail segment has an elongated hollow profile made of bent sheet metal and filler material. The hollow profile comprises at least the following regions: (i) a groove extending in the longitudinal direction of the hollow profile, which groove is formed by partial regions of the bent sheet metal and which forms an undercut, (ii) a first compartment, which is arranged next to the groove, projecting in a first lateral direction, which is delimited on four sides by partial regions of the bent sheet metal and which forms a first support surface for supporting the guide rail segment relative to a shaft wall of the elevator system, (iii) a second compartment, which is arranged next to the groove, projecting in a second lateral direction opposite to the first lateral direction, which is delimited on four sides by partial regions of the bent sheet metal and which forms a second support surface for supporting the guide rail segment relative to the shaft wall of the elevator system, and (iv) a third compartment which is arranged projecting from the groove in a height direction transverse to the lateral directions, which is delimited on four sides by partial regions of the bent sheet metal and which, with opposite lateral surfaces, forms a guide surface for guiding an elevator component to be displaced along the guide rail arrangement.

Each of the three compartments is delimited on one of its sides by a respective partial region of the bent sheet metal forming the groove. The filler material is received in the third compartment in such a manner that it rests on all four sides against the partial regions of the bent sheet metal that delimit the compartment on the respective side.

The bent sheet metal that forms the hollow profile, can be produced, for example, by means of a profiling process and, in particular, by means of a roll forming process. The hollow profile can advantageously be rolled from sheet metal, preferably steel sheet, and butt welded at a suitable location. In other words, the hollow profile can be a rolled sheet metal profile.

According to a second aspect of the invention, a guide rail arrangement is described which has a plurality of guide rail segments according to an embodiment of the first aspect of the invention, wherein the guide rail segments are arranged one after the other in the longitudinal direction and are connected to one another.

According to a third aspect of the invention, an elevator system is described which has an elevator shaft delimited by shaft walls, at least one guide rail arrangement according to an embodiment of the second aspect of the invention, which is fastened to one of the shaft walls, and an elevator component to be displaced, such as a car, which, guided on the guide rail arrangement, is displaceable along the elevator shaft.

According to a fourth aspect of the invention, a method for producing a guide rail segment is described. An elongated hollow profile is provided which has properties as already defined according to the first aspect of the invention. Filler material is then introduced into the third compartment of said hollow profile in such a manner that it rests on all four sides against the partial regions of the bent sheet metal that delimit the compartment on the respective side.

By way of introduction, a basic idea for embodiments of the invention described herein will be briefly explained; this explanation is to be interpreted as merely a rough summary and not as limiting the invention:

A guide rail segment is described which is not produced as a solid component made of solid material, for example in the form of steel, but rather with the aid of a hollow profile (produced, for example, by means of a profiling process and, in particular, by means of a roll forming process) made of bent sheet metal and which, as a result, offers several advantages over guide rails conventionally used in elevator systems. Such advantages comprise, for example, lower material requirements and therefore lower weight, as well as ease of assembly, reduced need for post-processing steps and/or improved sustainability.

The hollow profile comprises a longitudinal groove formed by the bent sheet metal as well as several elongated compartments adjacent to said groove. Two of these compartments serve, in particular, to form support surfaces with the help of which the guide rail segment can be supported on a shaft wall of the elevator system. A further compartment serves to form a guide surface along which an elevator component such as the car or a counterweight can be moved in a guided manner.

Since such a guide surface may be subjected to high forces during operation of the elevator system, in particular, said third compartment is mechanically reinforced by filling it at least partially with a filler material. The third compartment is configured and the filler material is introduced into it in such a manner that the filler material rests on all four sides within the third compartment on partial regions of the bent sheet metal forming the hollow profile, which delimit the third compartment on the respective side.

In this way, it can be achieved, among other things, that the filler material is reliably fastened within the third compartment, for example by frictional forces and/or adhesion forces between the filler material and an inwardly directed surface of the partial regions of the bent sheet metal delimiting the third compartment. On the other hand, the third compartment can be mechanically reinforced with the help of the filler material so that it can withstand, without damage, particularly high mechanical pressures such as those that may be exerted on the guide rail segment and, in particular, on the guide surface formed by it, during emergency braking.

Using a plurality of the described guide rail segments, a guide rail arrangement can be formed in an efficient manner and finally an elevator system can be equipped therewith.

To produce a guide rail segment, the described elongated hollow profile can be prepared first. This can be produced relatively easily, for example by roll forming, wherein a sheet metal joint can be welded together, for example. Furthermore, due to its relatively low weight, the hollow profile can be easily transported and/or installed in an elevator shaft. If necessary, the filler material may be introduced into the third compartment at or near an assembly site. In other words, the hollow profile can initially be transported without filler material, i.e., for example, brought to a building that houses the elevator system, and then the filler material can be introduced into the third compartment within the building or the elevator shaft located therein shortly before or, if necessary, after the hollow profile is attached to an elevator shaft.

Possible configurations and advantages of embodiments of the guide rail segment, the guide rail arrangement, the elevator system and the production method are described in more detail below.

The guide rail segment as described herein may have dimensions similar or identical to those of conventional, one-piece guide rail segments. Furthermore, it can be used to implement functionalities similar or analogous to those of conventional guide rails. In particular, a guide rail arrangement can be assembled from a plurality of guide rail segments by mounting the guide rail segments one after the other and adjacent to one another along the elevator shaft. The guide surfaces formed by adjacent guide rail segments preferably merge continuously into and flush with one another, so that a preferably flat, smooth guide surface is formed along the entire guide rail arrangement. A guide shoe attached to a car, for example, can then slide or roll along this guide surface and thereby guide the car along a desired travel path.

The guide rail segment is constructed in several parts and has at least one elongated hollow profile made of a bent sheet metal as well as filler material which partially or completely fills at least a partial region of said elongated hollow profile in the form of a third compartment. Outer partial surfaces of said third compartment form the guide surface, whereas the first and second compartments, together as a base part, are configured to be able to attach and support the guide rail segment to a shaft wall of the elevator system.

The hollow profile is elongated. For example, it can have a length of several meters, in particular more than 2 m, preferably more than 4 m, but in most cases less than 20 m or preferably less than 10 m. The hollow profile may be constructed in one piece or in multiple pieces. In particular, the hollow profile can be formed from a single sheet, in particular a metal sheet, preferably a steel sheet. For example, as already mentioned, the hollow profile may be produced using a roll forming process. Alternatively, the hollow profile may be produced as a bent component or a punched-bent component by suitable bending or bending and punching.

The hollow profile comprises several regions, which are sometimes also referred to as compartments and which preferably extend next to each other along the entire length of the hollow profile. A cross section of the hollow profile may remain the same along the entire length of the hollow profile. The regions or compartments preferably surround separate volumes within the hollow profile. Each of the regions or compartments is formed or surrounded by partial regions of the bent sheet metal. Accordingly, the different regions or compartments in the cross section of the hollow profile can be seen as clearly distinguishable areas.

As a central region, the hollow profile comprises a groove extending in the longitudinal direction of the hollow profile. Said groove is formed by a partial region of the sheet metal which is curved in such a manner that it surrounds a concave recess extending inwards into the hollow profile and is bent in such a manner that one or more undercuts are formed at one or more edges of the groove. The groove as a whole is configured in such a manner that a holding element such as a bolt or a screw may project into the groove and engages behind the undercut(s) with a widened region at one end of the holding element, e.g., a bolt head or a screw head. The holding element can be moved along the groove, i.e., its widened region can be displaced within the groove in the longitudinal direction of the groove.

The groove described can thus be used to fasten the guide rail segment with its hollow profile via the holding elements engaging in the groove, for example to a wall of an elevator shaft or to wall brackets (sometimes also referred to as “brackets”) fixed there. Due to the engagement of the holding elements with their widened regions behind the undercut(s) on the groove, the guide rail segment can be reliably fixed to the shaft wall and prevented from detaching or moving away from the shaft wall in a direction orthogonal to the shaft wall. On the other hand, due to the elongated design of the groove, it is possible for the guide rail segment, when mounted, to be displaced in a direction along the groove, i.e., vertically and parallel to the shaft wall. This makes it possible, for example, to allow relative movements between the shaft wall and the guide rail segment, such as those that may occur due to a settling of a building (also known as building shrinkage).

The first compartment and the second compartment are arranged adjacent to the groove on opposite side directions. The first compartment projects relative to the groove in a first lateral direction, whereas the second compartment projects relative to the groove in an opposite second lateral direction. Both compartments are formed by partial regions of the sheet metal forming the hollow profile, whereby these partial regions are shaped in such a manner that the respective compartment is delimited on four sides by the partial regions of the sheet metal. In other words, each compartment is substantially delimited on all sides by the sheet metal when viewed in the cross-sectional direction.

At least one of the partial regions of the sheet metal on the first compartment forms a first support surface, by means of which the guide rail segment can be supported relative to the shaft wall. In addition, at least one of the partial regions of the sheet metal on the second compartment forms a second support surface, by means of which the guide rail element can also be supported relative to the shaft wall. Both support surfaces can extend in a common plane. When mounting the guide rail segment within an elevator shaft, the support surfaces can, for example, rest against an elevator shaft wall or wall brackets fixed there and, in particular, divert compressive forces acting on the guide rail segment orthogonal to the shaft wall and/or possibly also lateral forces acting parallel to the shaft wall to the shaft wall.

The third compartment is arranged on the groove in a third lateral direction. This third lateral direction is oriented transversely, preferably perpendicularly, to the first and second lateral directions and is referred to herein as the height direction. The third compartment projects in the height direction relative to the groove. The third compartment is also delimited on four sides by partial regions of the bent sheet metal.

Two oppositely aligned partial regions, which form lateral surfaces of the third compartment, form a guide surface along which, for example, a guide shoe of an elevator component to be displaced, such as a car or a counterweight, can be guided. The guide surface consists of two surfaces, preferably running parallel to each other, on the outside of the third compartment. Said surfaces preferably extend substantially in or parallel to a plane spanned by a longitudinal direction of the hollow profile and by a direction orthogonal to the support surface.

In order to make the third compartment more resistant to compressive forces or clamping forces, such as those exerted on the guide surfaces when guiding an elevator component to be displaced along the guide surfaces and, in particular, when braking such an elevator component, for example during an emergency braking, the third compartment is reinforced by receiving the filler material into it. The filler material is introduced into the third compartment in such a manner that it is adjacent to all four sides the partial regions of the bent sheet metal that delimit the compartment there.

The filler material thus extends on the one hand in a direction parallel to the first or second lateral direction between the two opposite lateral surfaces which form the guide surface and supports it against compressive forces or clamping forces acting on it. On the other hand, the filler material also extends in a direction parallel to the height direction between a partial region of the sheet metal which delimits the groove on one surface and delimits the third compartment on an opposite surface, and a partial region of the sheet metal which is spaced apart and opposite thereto at the end of the third compartment directed away from the groove, so that the filler material is prevented from shifting in the height direction within the third compartment. In the longitudinal direction of the hollow profile, the filler material within the third compartment is generally held by frictional forces and/or adhesion forces, and possibly also by a positive fit.

According to one embodiment, the filler material fills the third compartment to at least 80%, preferably at least 90% or particularly preferably at least 99%, based on its cross section.

In other words, the volume occupied by the filler material corresponds to at least 80% of the total volume available within the third compartment. This means that at most minor volume fractions within the third compartment are not filled by the filler material, for example because the filler material itself has a certain porosity and cavities remain within the filler material or because the filler material does not reach small edge regions of the third compartment during filling. The filler material in the third compartment should preferably fill as completely as possible at least those partial volumes that extend between the opposite lateral surfaces forming the guide surface in order to support these lateral surfaces as effectively as possible against compressive forces or clamping forces acting on them.

According to one embodiment, the first compartment and the second compartment are at least 80%, preferably at least 90%, at least 95% or even completely free of filler material.

In other words, preferably only the third compartment is filled with filler material. The first and second compartments, however, are preferably essentially free of filler material. In this way, in particular, a weight of the guide rail segment can be kept low.

According to one embodiment, the filler material is a flowable, curing material. One embodiment of the production method may accordingly comprise filling the filler material in flowable form into the third compartment and subsequently curing the filler material in the third compartment.

In other words, the filler material can be flowable during a processing phase, i.e., liquid or pourable, and thus have viscous or plastically deformable properties. The filler material can thus be introduced into an internal volume of the third compartment, for example by pouring it into the third compartment from a longitudinal end of the hollow profile, thereby successively filling said internal volume. The filler material can then be cured within the third compartment, for example, due to chemical reactions or drying processes taking place there.

After said curing, the filler material within the third compartment may be fixed by frictional forces and/or adhesion forces, among others. If necessary, projections and/or recesses may be provided within the third compartment, around which the flowable filler material can flow or into which the filler material can flow, so that after its curing, a positive connection can be established between the filler material and the partial regions of the hollow profile forming the third compartment.

Concrete, mortar or plaster may be used as flowably processable filler materials. These materials have a very high compressive strength and can therefore very efficiently support the third compartment and, in particular, its opposite lateral surfaces forming the guide surface. In addition, these materials are usually easily and inexpensively available during the installation of a guide rail arrangement in a building. Alternatively, other flowably processable materials such as curable resins, thermosetting materials, thermoplastic materials or similar can serve as filler material. Furthermore, it would be conceivable to fill the third compartment by foaming. In this case, PU foam or PUR foam could be used as filler material.

According to a further specific embodiment, the third compartment may be sealed off from the first and second compartments in such a manner that, in the flowable state, at most 20% of the flowably processable filler material flows from the third compartment into at least one of the first and second compartments.

In other words, the bent sheet metal forming the hollow profile may be configured and, in particular, bent in such a manner that the third compartment is spatially completely separated from the first and second compartments or at least to such an extent that at most a negligible component of the flowably processable filler material introduced into the third compartment can escape into one of the other two compartments. The third compartment is thus completely or at least largely sealed from the other two compartments. For example, a partial region of the sheet metal surrounding the first compartment or the second compartment may directly rest against a partial region of the sheet metal surrounding the third compartment or may be separated from them only by a very narrow gap, so that no flowable filler material or at most negligible partial volumes of the flowable filler material can flow between these two partial regions.

For example, it is conceivable that concrete, mortar or plaster is used as the filler material and that any gap between partial regions of the sheet metal forming the hollow profile between the third compartment and one of the other compartments is so small that at most a small volume of water and/or a liquid-viscous solvent, as is typically present in concrete, mortar or plaster, can pass through this gap from the third compartment into one of the other compartments, but coarser components such as gravel or coarse sand, which are also typically present in the concrete, mortar or plaster, cannot pass through this gap.

According to an alternative embodiment, the filler material can be designed as a prefabricated component. One embodiment of the production method may comprise the steps of providing the filler material as a prefabricated component and introducing the component into the third compartment.

In other words, the filler material can be prefabricated separately from the hollow profile and then introduced into the third compartment of the hollow profile in the form of one or more units. For example, the filler material can be provided in the form of an elongated block of solid material. The block may have a length equal to or slightly shorter than the length of the hollow profile or a fraction of that length

Furthermore, the block may have a cross-sectional geometry which corresponds to the internal cross section of the third compartment, i.e., is substantially complementary thereto. In this case, wood, for example, can be used as a filler material. Wood is particularly durable, resilient, lightweight and generally inexpensive. However, other solid filler materials with similar properties, such as plastics, can also be used.

According to one embodiment, internal surfaces of the hollow profile can be protected against corrosion.

In other words, measures can be implemented on the guide rail segment to protect, in particular, the internal surfaces of the sheet metal forming its hollow profile against corrosion, in particular chemical oxidation. For this purpose, such surfaces can be provided with a sealing and/or corrosion-inhibiting coating, for example, in the form of a varnish, a layer or similar plated galvanically or in a de-energized manner. Such measures may be important in particular when corrosive substances are used as filler material. For example, water or other solvents contained in concrete, mortar or plaster can have a corrosive effect.

As an alternative or supplementary measure, according to one embodiment, the end faces of the hollow profile may be hermetically sealed.

Hermetic sealing of the end faces can, among other things, prevent corrosive substances such as in particular water and/or corrosion-promoting gases such as air from penetrating into the compartments of the guide rail segment during its service life. Sealing of the end faces can be achieved, for example, with a plug that engages sealingly in the hollow profile or by filling internal volumes in the hollow profile adjacent to the end faces with sealing material.

The guide rail segments described herein can be assembled to form a guide rail arrangement according to one embodiment of the second aspect of the invention. For this purpose, the guide rail segments are arranged one behind the other in the longitudinal direction and connected to each other. The guide surfaces of adjacent guide rail segments preferably adjoin one another directly and flush in order to form a common guide surface of the guide rail arrangement, along which, for example, a car can then be guided along an entire travel path spanned by the guide rail arrangement.

According to one embodiment, a connector insert may be arranged between each two guide rail segments that are adjacent to one another in the longitudinal direction, which connector insert is pressed into at least one of the compartments in a first of the two guide rail segments and into at least one of the compartments in a second of the two guide rail segments.

In other words, adjacent guide rail segments can be connected to one another, among other things, by pressing a connector insert (sometimes also referred to as an “inlay”) into their adjacent end faces, preferably with friction, so that this connector insert aligns the two guide rail segments flush with one another on the one hand and connects them to one another in a way that can withstand tensile loads on the other. The connector insert may, for example, be provided as a separate component and can be hammered into the respective end faces of the guide rail segments when assembling the guide rail arrangement. The connector insert can extend into one or more of the compartments. In particular, the connector insert may have a cross-sectional geometry that is complementary to one or more internal volumes of the compartments. The connector insert can be made of a material that can withstand high mechanical loads, such as metal, in particular steel.

It may be advantageous if the third compartment is filled with filler material in such a manner that it is arranged offset or shortened inwards relative to an end face of the guide rail segment with respect to the longitudinal direction, thereby creating a receiving space for the connector insert. If the filler material is concrete, for example, the concrete core in the guide rail segment can be slightly shorter, for example 20 cm and preferably 10 cm shorter, than the guide rail segment itself, so that the connector insert can still be inserted at the end face of the guide rail segment.

According to one embodiment, adjacent guide rail segments can be connected to one another via rail connector plates, which are fastened to the guide rail segments by means of fastening elements that engage in the grooves in the respective guide rail segments.

In other words, the undercut grooves optionally provided on the guide rail segments can be used not only to fasten the guide rail segments to the shaft wall or to a wall bracket anchored there doing so by means of fastening elements engaging in the grooves but also to fasten rail connector plates (sometimes also called fishplates) thereto, with the aid of which adjacent guide rail segments can be connected to one another in a sufficiently robust manner. In this case, the fastening elements can be, for example, screws, bolts or similar, the head of which can be inserted into the groove and thus engage behind the undercut. An opposite end of the fastening elements can then be fastened to the rail connector plate, for example screwed thereto. In this way, rail connector plates can be fastened to the adjacent guide rail segments quickly and easily, connecting them to each other in a mechanically loadable manner.

In an elevator system according to the third aspect of the invention, at least one of the guide rail arrangements described herein is fastened to one of the shaft walls. For this purpose, the individual guide rail segments can be fastened, for example, to anchored wall brackets. Since the guide rail segments are designed with an undercut groove as described above, the guide rail segments can be attached to the shaft wall via wall brackets, wherein the wall brackets are fastened to the guide rail segments by means of fastening elements that engage in the grooves in the corresponding guide rail segments.

It is to be noted that some of the possible features and advantages of the invention are described herein with reference to different embodiments of the guide rail segment described herein as well as of the guide rail arrangement and elevator system formed therewith, on the one hand, and, with reference to a production method, on the other hand. A person skilled in the art will recognize that the features can be combined, transferred, adapted or replaced as appropriate in order to arrive at further embodiments of the invention.

### BRIEF DESCRIPTION OF THE DRAWINGS

Embodiments of the invention will be described below with reference to the accompanying drawings, wherein neither the drawings nor the description are intended to be interpreted as limiting the invention.

FIG. 1 shows an elevator system according to an embodiment of the present invention.

FIG. 2 shows a sectional view of a hollow profile for a guide rail segment according to an embodiment of the present invention.

FIG. 3 shows a sectional view of a guide rail segment according to an embodiment of the present invention mounted on a wall bracket.

FIG. 4 shows a perspective view of a guide rail segment according to an embodiment of the present invention with a rail connector plate and a connector insert for connection to an adjacent guide rail segment.

The drawings are merely schematic and are not to scale. The same reference signs indicate the same or equivalent features.

### DETAILED DESCRIPTION OF EMBODIMENTS

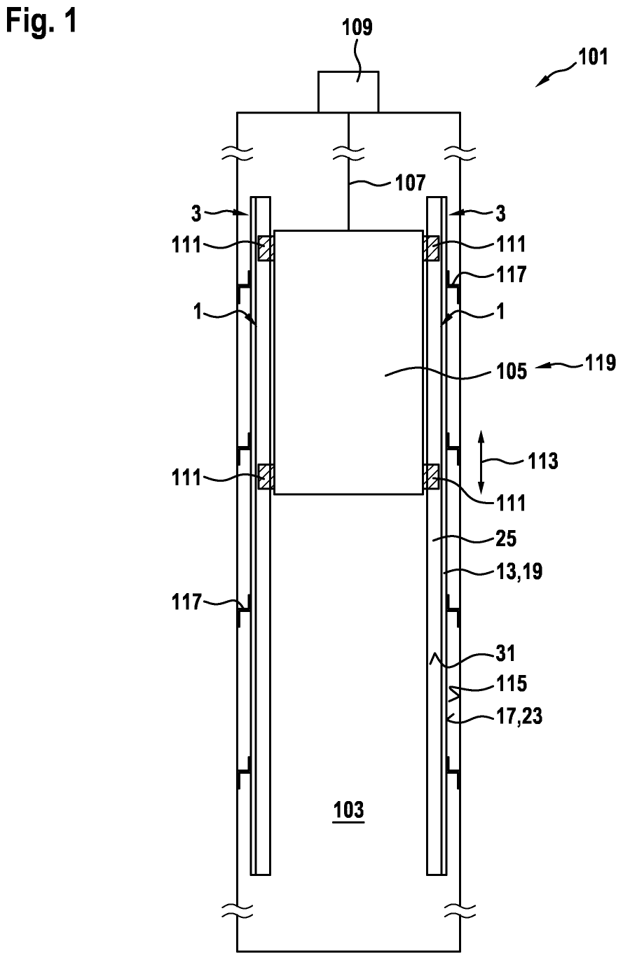

FIG. 1 shows an elevator system 101 having a guide rail arrangement 3 according to an embodiment of the invention. In an elevator shaft 103, an elevator component 119 to be displaced is received, for example in the form of a car 105 or a counterweight (not shown). The elevator car 105 is held by support means 107 and moved vertically along the elevator shaft 103 by a drive 109. The car 105 is guided along the guide rail arrangement 3 along guide surfaces 31 with the aid of guide shoes 111. The guide rail arrangement 3 is made up of a plurality of guide rail segments 1 which are arranged one after the other in a longitudinal direction 113 and connected to one another. The guide rail segments 1 are supported and fastened with support surfaces 17, 23 on wall brackets 117 (“brackets”), which are anchored in the shaft wall 115.

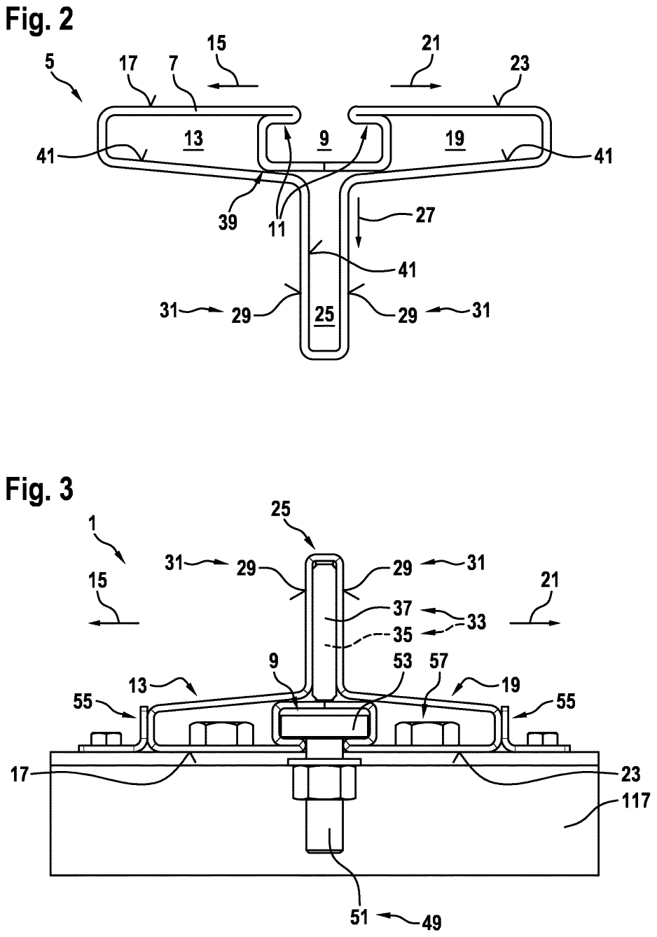

FIG. 2 shows a hollow profile 5 for a guide rail segment 1 in cross section. FIG. 3 shows guide rail segment 1 which is fastened to a wall bracket 117.

The hollow profile 5 comprises a plurality of regions or compartments 13, 19, 25, which are formed by suitable bending of sheet metal 7 and are each delimited and separated from one another by partial regions of the sheet metal 7. The previously mentioned bending of the sheet metal 7 can be done during a profiling process. The bending of the sheet metal 7 may, for example, be a roll bending process. Preferably, the hollow profile 5 can be produced by means of a roll forming process. The hollow profile 5 is thus advantageously rolled from sheet metal 7 and butt-welded at a suitable point.

In particular, the hollow profile 5 comprises a groove 9. The groove 9 extends in the longitudinal direction 113 of the hollow profile 5. The groove 9 is configured in such a manner that a widened region such as a screw head 53 of a screw 51 serving as a fastening element 49 can be received therein. The groove 9 is provided with an undercut 11 on each of its lateral edges. The undercuts 11 are formed by suitable bending of the sheet metal 7. These undercuts 11 can be engaged by the screw head 53. The screw 51 can thus, on the one hand, be displaced (“slide”) within the elongated groove 9 in the longitudinal direction 113 and, on the other hand, can hold the hollow profile 5 in a direction orthogonal to the longitudinal direction 113 by engaging behind the undercuts 11 in order to be able to fasten it, in particular, to one of the wall brackets 117.

Due to this functionality, which is also referred to as the slide function, the assembly speed can be increased, since only one screw 51 per wall bracket 117 needs to be tightened in order to fix the guide rail segment 1 to the corresponding wall bracket 117. The screw 51 can be tightened with only a small torque in order to allow the screw 51 to slide within the groove 9 and thus to allow at least a slight displacement of the guide rail segment 1 vertically relative to the shaft wall 115. In this way, shrinkage of the building accommodating the elevator system 101 can be compensated, for example. The groove 9 can also be used to attach other components or additional equipment to the guide rail segment 1.

Starting from the groove 9 as the central region, several compartments 13, 19, 25 extend in different directions 15, 21, 27 on the guide rail segment 1.

In particular, a first compartment 13 projecting in a first lateral direction 15 and a second compartment 19 projecting in an opposite second lateral direction 21 extend on opposite sides next to the groove 9. The first and second compartments 13, 19 are each delimited on four sides by suitably bent partial regions of the sheet metal 7. The first compartment 13 forms a first support surface 17 and the second compartment 19 forms a second support surface 23. The two support surfaces 17, 23 extend in a common plane on the opposite sides adjacent to an opening of the groove 9. By means of the support surfaces 17, 23, the guide rail segment 1 can be supported, for example, on a surface of the wall bracket 117 anchored in the shaft wall 115 and thus relative to the shaft wall 115.

A third compartment 25 projects from the groove 9 in a height direction 27 perpendicular to the lateral directions 15, 21. The third compartment 25 is also delimited on four sides by suitably bent partial regions of the sheet metal 7. Opposite lateral surfaces 29 form the guide surface 31 for guiding the elevator component 119 to be displaced. The lateral surfaces 29 run orthogonally to the first lateral direction 15 or the second lateral direction 21.

As shown in FIG. 3, filler material 33 is received in the third compartment 25. In the example shown, the filler material 33 is designed as a prefabricated component 37, for example in the form of a wooden block serving as a wooden core. The wood may be treated to protect it against mold and/or fire, for example. The wooden block can, for example, be pressed or hammered into the third compartment 25 in the longitudinal direction 113. In an alternative embodiment, the filler material 33 can be filled into the interior of the third compartment 25 as a flowable, processable curing filler material 35 (referenced by dashed lines), for example in the form of concrete, mortar or plaster. Once it has been cured there, it can form a solid concrete, mortar or plaster core.

In both cases, the filler material 33 is received in the third compartment 25 in such a manner that it rests against the partial regions of the sheet metal 7 on all four sides, which delimit the third compartment 25 on the respective side. The filler material 33 thus supports these partial regions of the sheet metal 7 from the inside. As a result, with the help of the filler material 33, in particular the lateral walls extending in the height direction 27, which form the lateral surfaces 29 serving as the guide surface 31, are stabilized so that they can, for example, withstand more strongly guiding or clamping forces acting orthogonally thereon.

The sheet metal 7 forming the hollow profile 5 is bent in such a manner that the various compartments 13, 19, 25 form volume regions that are largely separated from one another. In particular, the third compartment 25 is delimited from the first and second compartments 13, 19 in such a manner that a flowable filler material 35 used to fill the third compartment 25 cannot flow, or at most can flow in negligible amounts, from the third compartment 25 into one of the other compartments 13, 19.

For this purpose, partial regions of the sheet metal 7, which delimit the respective compartments 13, 19, 25 and adjoin one another, may be bent in direct mechanical contact with one another, so that there is no direct connection between the compartments 13, 19, 25. Alternatively, a slight gap 39 (indicated in FIG. 2) may exist between these partial regions, wherein this gap 39 may be so narrow that at most insignificant amounts of flowable filler material 35 can pass through this gap 39. For example, the gap 39 may be dimensioned in such a manner that water contained in flowable filler material 35 in the form of concrete, mortar or plaster can escape through this gap 39, but not gravel or coarse sand also contained therein.

In order to protect the hollow profile 5 against damage caused by corrosion, its internal surfaces 41 may, for example, be coated or otherwise protected against corrosion. Furthermore, end faces 43 of the hollow profile 5 can be hermetically sealed, in particular to prevent the penetration of moisture.

In order to be able to hold the guide rail segment 1 in position in the two lateral directions 15, 21, in the example shown, stop segments 55 are fastened to the wall bracket 117 on both sides next to the guide rail segment 1. Said stop segments 55 may be required because the screw 51 is preferably only slightly tightened in order to continue to allow displacement of the guide rail segment 1 in its longitudinal direction 113.

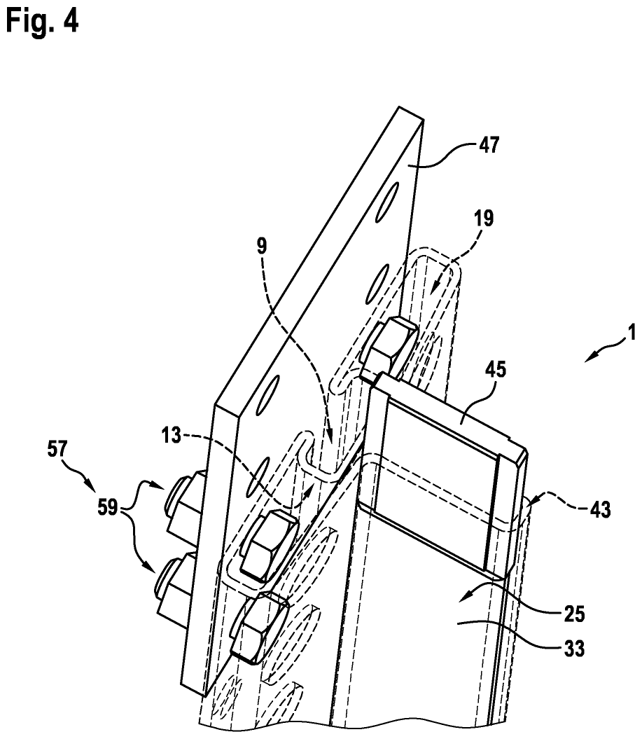

In order to form the entire guide rail arrangement 3, several guide rail segments 1 are arranged adjacent to one another in the longitudinal direction 113 and are mechanically connected to one another. As illustrated in FIG. 4, a connector insert 45 (“inlay”) can be pressed into at least one of the compartments 13, 19, 25 in the two adjacent guide rail segments 1 (whereby only one guide rail segment 1 is shown for simplified illustration). In particular, the connector insert 45 may be pressed into the respective third compartments 25 in order to align the guide surfaces 31 of the two guide rail segments 1 formed thereby in a manner that is flush with one another and capable of withstanding mechanical loads. The filling formed with the filler material 33, such as the wooden core or concrete core, may be slightly shorter, e.g., 10 cm shorter, than the guide rail segment 1 itself, so that the connector insert 45 can still be inserted at the end face 43 of the guide rail segment 1.

Alternatively or additionally, the adjacent guide rail segments 1 can be connected to one another via rail connector plates 47 (“fishplates”). The rail connector plates 47 can be fastened to the adjacent guide rail segments 1 in the region of the end faces 43 using fastening elements 57 such as screws 59. For this purpose, the fastening elements 57 can engage in holes in the hollow profile 5, which are provided, for example, in the first and second compartments 13, 19 near the end faces 43, and/or engage in the grooves 9 in the two guide rail segments 1.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1. -15. (canceled)

16. A guide rail segment of a guide rail arrangement for an elevator system, comprising:
an elongated hollow profile made of bent sheet metal; and
a filler material;
wherein the hollow profile comprises:
a groove extending in a longitudinal direction of the hollow profile, wherein the groove is formed by partial regions of the bent sheet metal, and wherein the groove forms an undercut;
a first compartment arranged next to the groove and extending in a first lateral direction, the first compartment delimited on four sides by partial regions of the bent sheet metal, wherein the first compartment forms a first support surface for supporting the guide rail segment relative to a shaft wall of the elevator system;
a second compartment arranged next to the groove and extending in a second lateral direction opposite to the first lateral direction, the second compartment delimited on four sides by partial regions of the bent sheet metal, wherein the second compartment forms a second support surface for supporting the guide rail segment relative to the shaft wall of the elevator system; and
a third compartment arranged next to the groove and extending in a height direction transverse to the first and the second lateral direction, the third compartment delimited on four sides by partial regions of the bent sheet metal, wherein the third compartment, with opposite lateral surfaces, forms a guide surface for guiding an elevator component to be displaced along the guide rail arrangement;
wherein each of the first, second, and third compartments is delimited on one side by a respective partial region of the bent sheet metal forming the groove; and
wherein the filler material is received in the third compartment in such a manner that the filler material rests on all four sides against the partial regions of the bent sheet metal, delimiting the third compartment on a respective one of the sides.

17. The guide rail segment according to claim 16, wherein the filler material fills the third compartment to at least 80% of a volume thereof.

18. The guide rail segment according to claim 16, wherein the first compartment and the second compartment are at least 80% free of the filler material.

19. The guide rail segment according to claim 16, wherein the filler material is a flowable, processable, and curable filler material.

20. The guide rail segment according to claim 19, wherein the third compartment is sealed from the first and second compartments in such a manner that, in a flowable state, at most 20% of the filler material flows from the third compartment into at least one of the first and second compartments.

21. The guide rail segment according to claim 16, wherein the filler material is a prefabricated component.

22. The guide rail segment according to claim 16, wherein internal surfaces of the hollow profile are protected against corrosion.

23. The guide rail segment according to claim 16, wherein one or more end faces of the hollow profile are hermetically sealed.

24. A guide rail arrangement, comprising:
a plurality of guide rail segments, each of the plurality of guide rail segments comprising:
an elongated hollow profile made of bent sheet metal; and
a filler material;
wherein the hollow profile comprises:
a groove extending in a longitudinal direction of the hollow profile, wherein the groove is formed by partial regions of the bent sheet metal, and wherein the groove forms an undercut;
a first compartment arranged next to the groove and extending in a first lateral direction, the first compartment delimited on four sides by partial regions of the bent sheet metal, wherein the first compartment forms a first support surface for supporting the guide rail segment relative to a shaft wall of the elevator system;
a second compartment arranged next to the groove and extending in a second lateral direction opposite to the first lateral direction, the second compartment delimited on four sides by partial regions of the bent sheet metal, wherein the second compartment forms a second support surface for supporting the guide rail segment relative to the shaft wall of the elevator system; and
a third compartment arranged next to the groove and extending in a height direction transverse to the first and the second lateral direction, the third compartment delimited on four sides by partial regions of the bent sheet metal, wherein the third compartment, with opposite lateral surfaces, forms a guide surface for guiding an elevator component to be displaced along the guide rail arrangement;
wherein the guide rail segments are arranged one after the other in a longitudinal direction and are connected to one another.

25. The guide rail arrangement according to claim 24, wherein between two guide rail segments, which are adjacent to one another in the longitudinal direction, a connector insert is arranged, which is pressed into at least one of the first, second, and third compartments in a first of the two guide rail segments and into at least one of the first, second, and third compartments in a second of the two guide rail segments.

26. The guide rail arrangement according to claim 24, wherein adjacent guide rail segments are connected to one another via rail connector plates which are fastened to the guide rail segments by means of fastening elements which engage in the grooves in the corresponding guide rail segments.

27. An elevator system, comprising:
an elevator shaft delimited by shaft walls;
at least one guide rail arrangement according to claim 24, which is fastened to one of the shaft walls; and
an elevator component to be displaced, which can be displaced along the elevator shaft, guided on the at least one guide rail arrangement.

28. The elevator system according to claim 27, wherein the guide rail segments are fastened to one of the shaft walls via wall brackets, and wherein the wall brackets are fastened to the guide rail segments by means of fastening elements which engage in the grooves in the corresponding guide rail segments.

29. A method for producing a guide rail segment of a guide rail arrangement for an elevator system, the method comprising:
providing an elongated hollow profile made of bent sheet metal, wherein the hollow profile comprises:
a groove extending in a longitudinal direction of the hollow profile, wherein the groove is formed by partial regions of the bent sheet metal, and wherein the groove forms an undercut;
a first compartment arranged next to the groove and extending in a first lateral direction, the first compartment delimited on four sides by partial regions of the bent sheet metal, wherein the first compartment forms a first support surface for supporting the guide rail segment relative to a shaft wall of the elevator system;
a second compartment arranged next to the groove and extending in a second lateral direction opposite to the first lateral direction, the second compartment delimited on four sides by partial regions of the bent sheet metal, wherein the second compartment forms a second support surface for supporting the guide rail segment relative to the shaft wall of the elevator system; and
a third compartment arranged next to the groove and extending in a height direction transverse to the first and the second lateral direction, the third compartment delimited on four sides by partial regions of the bent sheet metal, wherein the third compartment, with opposite lateral surfaces, forms a guide surface for guiding an elevator component to be displaced along the guide rail arrangement;
wherein each of the first, second, and third compartments is delimited on one side by a respective partial region of the bent sheet metal forming the groove; and
introducing a filler material into the third compartment in such a manner that the filler material rests on all four sides against the partial regions of the bent sheet metal, delimiting the third compartment on a respective one of the sides.

30. The method according to claim 29, wherein the filler material is introduced by means of one of the following steps:
providing the filler material as a flowable, processable, and curable filler material, filling the filler material into the third compartment, and subsequently curing the filler material in the third compartment; or
providing the filler material as a prefabricated component and inserting the prefabricated component into the third compartment.
